(19) United States
(12) Patent Application Publication
(10) Pub. No.: US 2022/0159720 A1
(43) Pub. Date: May 19, 2022

(54) MECHANISM FOR TRANSMISSION FOR WIDEBAND SYSTEM IN UNLICENSED SPECTRUM

(71) Applicant: Nokia Solutions and Networks Oy, Espoo (FI)

(72) Inventors: Tao TAO, Shanghai (CN); Jianguo LIU, Shanghai (CN); Yan MENG, Shanghai (CN); Mark MARSAN, Elmhurst, IL (US)

(73) Assignee: Nokia Solutions and Networks Oy, Espoo (FI)

(21) Appl. No.: 17/439,497

(22) PCT Filed: May 13, 2019
(86) PCT No.: PCT/CN2019/086591

§ 371 Date: Sep. 15, 2021

(51) Int. Cl. H04W 74/08; H04L 1/00

(52) U.S. Cl. CPC H04W 74/0808; H04L 1/0068; H04W 74/0875

(57) ABSTRACT

Embodiments of the present disclosure relate to mechanism for transmission for wideband system in unlicensed spectrum. According to embodiments of the present application, a transmission coordination mechanism is proposed to facilitate transmission in a wideband system. The network device may puncture on-going transmission on neighbor bands to ensure no power leakage to the band with later transmission. In this way, it can minimize the in-device power leakage issue when the network device performs LBT for later transmission.

### FIELD

Embodiments of the present disclosure generally relate to the field of communications and in particular, to a method, device, apparatus and computer readable storage medium for transmission in the wide system in the unlicensed spectrum.

### BACKGROUND

In recent communication systems, unlicensed spectrum has been introduced to increase capacity of the communication systems. For example, the unlicensed spectrum may allow cellular network operators to offload some of data traffic by accessing the unlicensed frequency band. In some communication systems (for example, Long-term Evolution), the maximum system bandwidth is 20 MHz. Carrier aggregation (CA) is used as the solution to support wider bandwidth operation. Different from LTE system, New Radio systems support wider bandwidth operation due to the benefit of higher spectrum utilization and lower baseband complexity. Both carrier aggregation and bandwidth part (BWP) mechanisms are supported in New Radio for wideband operation.

### SUMMARY

Generally, embodiments of the present disclosure relate to a method for transmission in the wideband system for the unlicensed spectrum and the corresponding communication devices.

In a first aspect, there is provided a first device. The first device comprises at least one processor; and at least one memory including computer program codes; the at least one memory and the computer program codes are configured to, with the at least one processor, cause the first device to determine a configuration of a transmission gap. The first device is further caused to generate a transmission gap in a first transmission from the first device to a second device, the first transmission performed on a first band. The first device is also caused to perform a channel available assessment on a second band during the transmission gap, the second band being adjacent to the first band. The first device is further caused to determine whether the second band is available based on the assessment. The first device is yet caused to in response to a determination that the second band is available, perform a second transmission from the first device to the second device on the second band.

In a second aspect, there is provided a second device. The second device comprises at least one processor; and at least one memory including computer program codes; the at least one memory and the computer program codes are configured to, with the at least one processor, cause the second device to receive data on a first band from a first device. The second device is also caused to receive an indication of a transmission gap and a configuration of the transmission gap from the first device, the transmission gap being generated on the first band. The second device is further caused to decode the data based on the configuration of the transmission gap.

In a third aspect, there is provided a method. The method comprises determining, at a first device, a configuration of a transmission gap. The method further comprises generating a transmission gap in the first transmission from the first device to a second device, the first transmission performed on a first band. The method also comprises performing a channel available assessment on a second band during the transmission gap, the second band being adjacent to the first band. The method further comprises determining whether the second band is available based on the assessment. The method yet comprises in response to a determination that the second band is available, performing a second transmission from the first device to the second device on the second band.

In a fourth aspect, there is provided a method. The method comprises receiving, at a second device, data on a first band from a first device. The method also comprises receiving an indication of a transmission gap and a configuration of the transmission gap from the first device, the transmission gap being generated on the first band. The method further comprises decoding the data based on the configuration of the transmission gap.

In a fifth aspect, there is provided an apparatus comprising means for generating a transmission gap in a first transmission from a first device to a second device, the first transmission performed on a first band; means for performing a channel available assessment on a second band during the transmission gap, the second band being adjacent to the first band; means for determining whether the second band is available based on the assessment; and means for in response to a determination that the second band is available, performing a second transmission from the first device to the second device on the second band.

In a sixth aspect, there is provided an apparatus comprising receiving, at a second device, data on a first band from a first device; means for receiving an indication of a transmission gap and a configuration of the transmission gap from the first device, the transmission gap being generated on the first band; and means for decoding the data based on the configuration of the transmission gap.

In a seventh aspect, there is provided a non-transitory computer readable medium comprising program instructions for causing an apparatus to perform at least the method according to the third and/or fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates a schematic diagram of power leakage according to conventional technologies;

FIG. 2 illustrates a schematic diagram of transmissions in wideband systems according to conventional technologies;

FIG. 3 illustrates a schematic diagram of transmissions in wideband systems according to conventional technologies;

FIG. 4 illustrates a schematic diagram of a communication system according to embodiments of the present disclosure;

FIG. 5 illustrates a flow chart of a method implemented at a communication device according to embodiments of the present disclosure;

FIG. 6 illustrates a schematic diagram of transmissions in wideband systems according to embodiments of the present disclosure;

FIG. 7 illustrates a schematic diagram of transmissions in wideband systems according to embodiments of the present disclosure;

FIG. 8 illustrates a schematic diagram of transmissions in wideband systems according to embodiments of the present disclosure;

FIG. 9 illustrates a schematic diagram of transmissions in wideband systems according to embodiments of the present disclosure;

FIG. 10 illustrates a schematic diagram of transmissions in wideband systems according to embodiments of the present disclosure;

FIG. 11 illustrates a flow chart of a method implemented at a communication device according to embodiments of the present disclosure;

FIG. 12 illustrates a schematic diagram of a device according to embodiments of the present disclosure; and

FIG. 13 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a user equipment and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which user equipment accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, unlicensed spectrum has been introduced to increase capacity of the communication systems. There are several technologies for supporting unlicensed spectrum, for example, Licensed Assisted Access (LAA), LTE-Unlicensed (LTE-U) and MuLTEfire. There are several wide unlicensed frequency bands available, and terminal devices in New Radio (licensed band) may be able to support 100 MHz BW for FR1 and 200 MHz in FR2. Therefore, even a single network device or a terminal device can occasionally access very wide bandwidths comprising multiple 20 MHz channels.

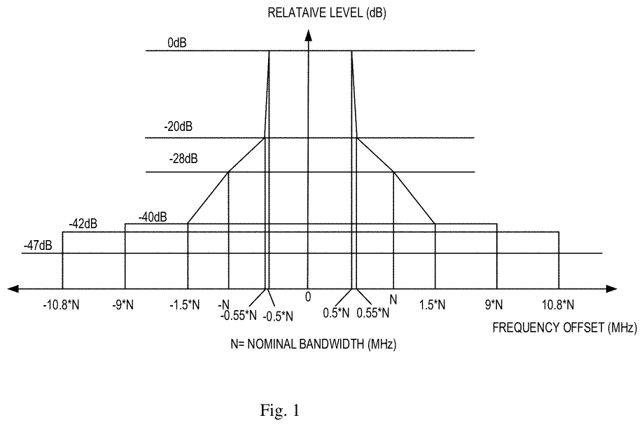

An issue for multi-carrier or wideband operation in unlicensed spectrum is in-device power leakage. More specifically, emitted power from on-going transmission in one operating channel may block the LBT procedure performing in neighbor operating channels. FIG. 1 illustrates transmission power mask. It can be observed that the leakage power to neighbor channels could be as large as −20 dB.

The power leakage may result in unwanted LBT block in neighbor operating channels. For example, a transmission is performed in operating channel #1. Neighbor operating channel (e.g., #2) may receive leakage power from operating channel #1 while it performs the channel sensing before a transmission. Therefore, a transmission to be transmitted in operating channel #2 will be blocked, since the channel sensing will fail due to in-device power leakage from the transmission in operating channel #1.

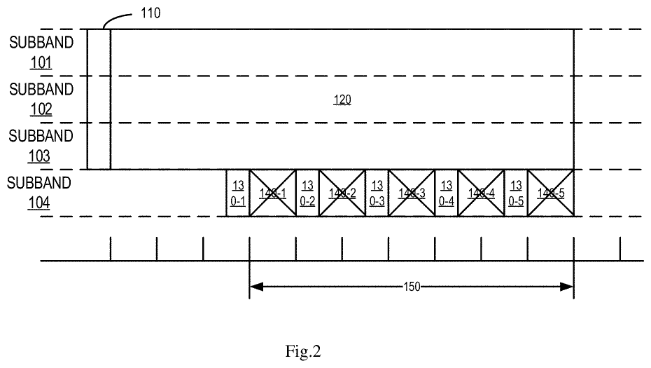

FIG. 2 illustrates a system with 80 MHz transmission bandwidth which contains four 20 MHz sub-bands, for example, subband 101, subband 102, subband 103 and subband 104. A discovery signaling (DRS) may be transmitted in one of the sub-band, for example, the subband 104. The network device may perform a clear channel assessment (CCA) on the slot 110 and may transmit downlink (DL) burst 120 on the first three subbands (for example, the subband 101, the subband 102, the subband 103 and the subband 104) during the DRS transmission window 150. The transmission 120 may cause the network device fails in the CCA on the slots 130-1, 130-2, 130-3, 130-4 and 130-5 due to the in-device power leakage. Thus, the DRS cannot be transmitted during periods 140-1, 140-2, 140-3 and 140-4.

DRS transmission block has a big impact on the system robustness. It may delay the new device initial access due to lack of synchronization signaling and system information. It may impact the cell maintenance and UE mobility due to lack of reference signal.

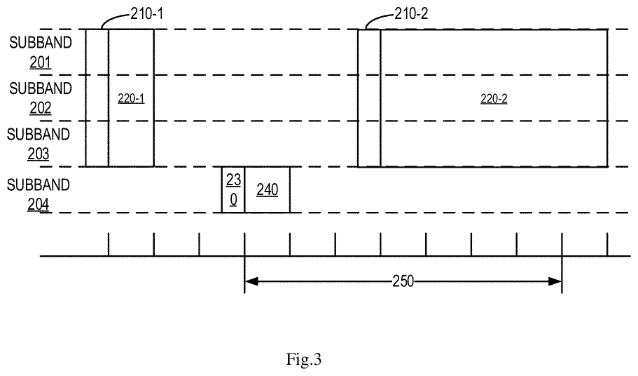

One of the conventional methods is to stop the on-going transmission on neighbor subbands before DRS transmission window. As shown in FIG. 3, the network device may perform a clear channel assessment (CCA) during the slot 210-1 and may transmit downlink (DL) burst 220-1 on the first three subbands (for example, the subband 201, the subband 202, the subband 203 and the subband 204). The network device may stop the transmission 210-1 on neighbour bands before DRS transmission window 250. The network device may perform the CCA on the subband 204 during the slot 230. The CCA is successful since there is no power leakage on the subband 204 during the slot 230. The network device may transmit the DRS on the slot 240. After DRS transmission, the transmission 220-2 on neighbor subbands may try to resume after LBT operation on slot 210-2.

However, the transmission efficiency on neighbor subbands may be decreased. Discontinuous transmission with long idle duration (for defer access) may result in additional LBT operation overhead. Furthermore, stop-and-resume may also delay the data transmission, which may impact the performance of latency-sensitive traffic.

According to embodiments of the present application, a transmission coordination mechanism is proposed to facilitate transmission in a wideband system. The network device may puncture on-going transmission on neighbor bands to ensure no power leakage to the band with later transmission. In this way, it can minimize the in-device power leakage issue when the network device performs LBT for later transmission.

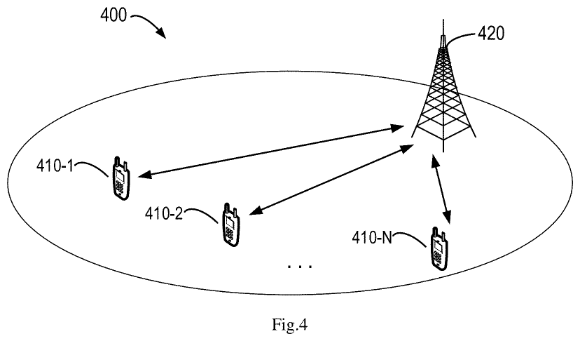

FIG. 4 illustrates a schematic diagram of a communication system 400 in which embodiments of the present disclosure can be implemented. The communication system 400 comprises the first devices 410 and the second device 420. For the purpose of illustrations, the first devices 410 may be referred to as the terminal device 410 and the second device 420 may be referred to as the network device 420 hereinafter. It should be noted that the first devices and the second devices are interchangeable. For example, the procedures which are described to be implemented at the terminal device may also be able to be implemented at the network device and the procedures which are described to be implemented at the network device may also be able to be implemented at the terminal device.

The link from the second device 420 to the first devices 410 may be referred to as the “first link” and the link from the first devices 410 to the second device 420 may be referred to as the “second link.” It should be noted that the first link and the second link are interchangeable.

The communication system 400, which is a part of a communication network, comprises terminal devices 410-1, 410-2, . . . , 410-N (collectively referred to as “terminal device(s) 410” where N is an integer number). The communication system 400 comprises one or more network devices, for example, a network device 420. It should be understood that the communication system 400 may also comprise other elements which are omitted for the purpose of clarity. It is to be understood that the numbers of terminal devices and network devices shown in FIG. 4 are given for the purpose of illustration without suggesting any limitations. The terminal devices 410 and the network device 420 may communicate with each other. Only for the purpose of illustrations, the network device 420 is shown as a base station.

It is to be understood that the number of network devices and terminal devices is only for the purpose of illustration without suggesting any limitations. The system 400 may include any suitable number of network devices and terminal devices adapted for implementing embodiments of the present disclosure.

Communications in the communication system 400 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

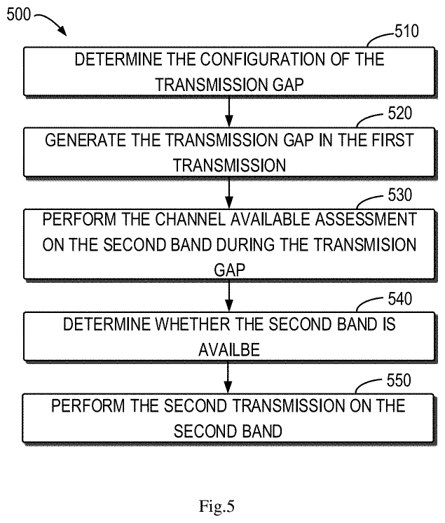

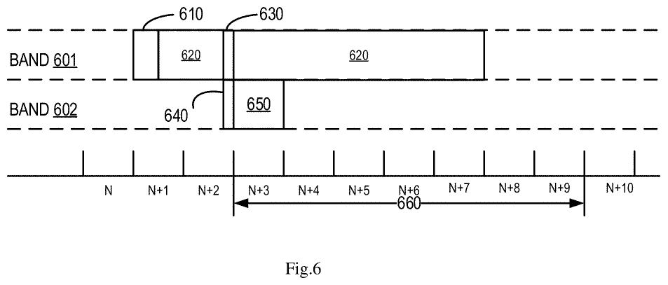

FIG. 5 illustrates a flow chart of a method 500 in accordance with embodiments of the present disclosure. The method 500 may be implemented at any suitable devices. Only for the purpose of illustrations, the method 500 is described to be implemented at the network device 420. It should be noted that the method 500 may also be implemented at the terminal device 410. FIGS. 6-10 illustrate schematic diagrams of transmissions in wideband system. The method 400 is described with the reference to FIGS. 6-10. It should be noted that the numbers of bands shown in FIGS. 6-10 are only examples, not limitations. Embodiments of the present disclosure are able to be implemented in any suitable number of bands. The term “band” used herein may refer to a subband with a suitable bandwidth. The term “band” may also refer to a carrier a suitable bandwidth. The term “band” may further refer to a channel with a suitable bandwidth.

In some embodiments, as shown in FIG. 6, the network device 420 may perform the CCA on the band 601 during the period 610. The network device 420 may perform the transmission 620 on the band 601 after the CCA is successful.

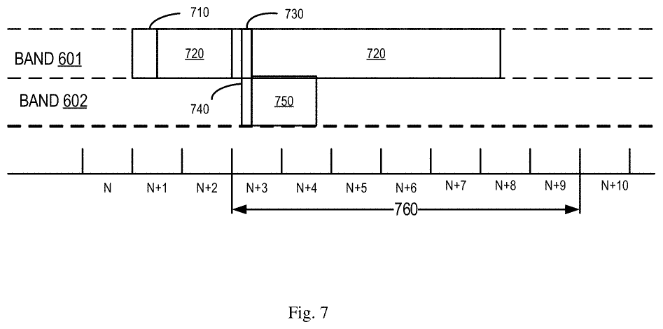

In some embodiments, as shown in FIG. 7, the network device 420 may perform the CCA on the band 601 during the period 710. The network device 420 may perform the transmission 720 on the band 601 after the CCA is successful.

At block 510, the network device 420 determines the configuration of the transmission gap. The network device 420 may determine the end position of the transmission gap based on the potential start position of the second transmission (for example, the transmissions 650 and 750) on the second band (for example, the bands 602 and 702). The network device 420 may also determine the duration of the transmission gap based on the duration of listen-before-talk measurements on the second band. The first and second bands are adjacent. In some embodiments, the first and second bands may be next to each other. Alternatively, there may be several bands between the first and second bands.

As shown in FIG. 6, the second transmission 650 may start from the slot boundary and the window for the transmission 650 may be the duration 660 (from slot n+4 to slot n+10). The period for performing the listen-before-talk measurement may be the duration 640. The network device 420 may determine the duration of the transmission gap 630 is the same as the duration 640 and determine the start position to be the duration 640 earlier than the start position of the second transmission 650.

At block 520, the network device 420 generates the transmission gap (for example, the transmission gaps 630 and 730) on the first transmission (for example, the transmissions 620 and 720) from the network device 420 to the terminal device 110-1. The first transmission is on the first band (for example, the bands 601 and 701). In some embodiments, the first transmission may be a broadcast transmission. Alternatively, the first transmission may be a unicast transmission. Embodiments of the present disclosure are not limited in this aspect.

As shown in FIG. 7, the transmission 750 may not start from the slot boundary and the window for the transmission 750 may be the duration 760 (from slot n+4 to slot n+10). The period for performing the listen-before-talk measurement may be the duration 740. The network device 420 may determine the duration of the transmission gap 730 based on the duration 740.

In some embodiments, the network device 420 may generate the transmission gap by data puncturing. For example, the network device 420 may puncture data in the transmission. In some embodiments, the network device 420 may determine a period of time in a duration of the first transmission such that no data is transmitted in the period of time.

As shown in FIG. 6, assuming the duration for the LBT measurement is 25 us, the network device 420 may puncture the last 25 us of physical downlink shared channel (PDSCH) transmitted in slot n+2, in order to create the transmission gap 630 for the LBT measurement. As another example, the network device 420 may puncture the last symbol of PDSCH transmitted in slot n+2. Within the transmission gap 630, the network device 420 may perform one-shot CCA in all bands (bands 601 and 602). If CCA in all bands is successful, the transmission 620 may continue and the transmission 650 may be transmitted in slot n+3.

As mentioned above, since the second transition may not start from the slot boundary, the network device 420 may determine the gap position accordingly. As shown in FIG. 7, the transmission 750 may from symbol #1 of a slot and the first symbol is punctured to provide 25 us as the transmission gap. In this way, data part of the prior symbol is not punctured and the control region is shortened to provide room for CCA gap.

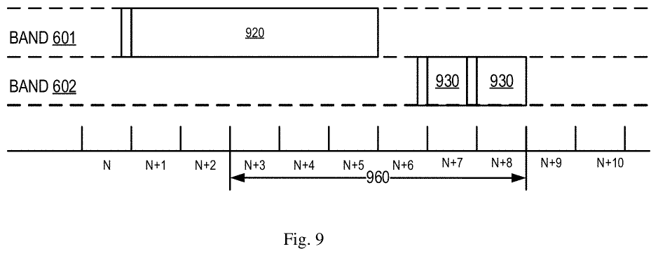

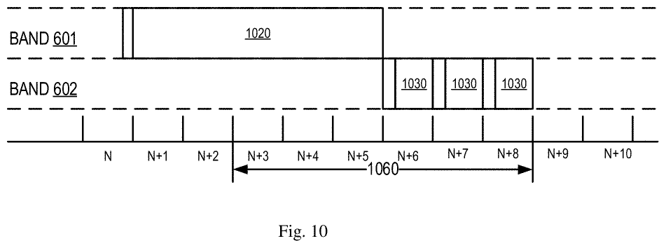

In some embodiments, if the first transmission overlaps the second transmission, no data puncturing is utilized. Without the use of puncturing, an unused slot is needed to provide a period of time to be the gap transmission before the start of the second transmission. As shown in FIG. 9, the transmission 920 finishes at the slot n+5. According to conventional technology, even though there are 3 slots left in the window 960, only two LBT measurements are possible since the first LBT measurement is at the end of slot n+5. According to embodiments of the present disclosure, it is possible to provide LBT in the first symbol of the slot of the second transmission and an additional LBT measurement opportunity is provided. As shown in FIG. 10, the transmission 1020 finishes at the slot n+5 and there are 3 slots left in the window 1060, three LBT measurements may possible in slots n+5, n+6 and n+7, respectively.

Alternatively, the network device 420 may generate the transmission gap by rate-matching. The network device 420 may match the number of bits in transport block to the number of bits that can be transmitted in the given allocation. For example, the network device 420 may regenerate a transport block for the first transmission with a new transport block size by avoiding data transmission in the transmission gap.

In some embodiments, the network device 420 may also determine the number of bands on which the transmission gaps need to be created. The number of bands on which the transmission gaps need to be created may be determined based on the number of bands on which transmissions are currently performing.

At block 520, the network device 420 performs the channel available assessment on the second band during the transmission gap. The network device 420 may performs any suitable types of listen-before-talk operation on the second band. For example, the network device 420 may listen to the second band to see whether any other transmissions are occupying the second band. In some embodiments, the network device 420 may also perform the channel available assessment on the first band during the transmission gap.

In some embodiments, the network device 420 may perform the CCA on the second bands. Alternatively, the network device 420 may perform the CCA on all bands. In this way, the result of the LBT measurement for the second transition is not affected by the power leakage of the first transmission, thereby increasing the transmission opportunities. In some embodiments, the second transmission may have higher priority than the first transmission. For example, the second transmission may be DRS. Alternatively, the second transmission may contain ultra-reliable low latency (URLLC) traffic. Embodiments of the present disclosure are not limited in this aspect. In some embodiments, the second transmission may be a broadcast transmission. Alternatively, the second transmission may be a unicast transmission. Embodiments of the present disclosure are not limited in this aspect.

As shown in FIG. 6, the network device 420 may perform the channel available assessment measurement during the transmission gap 630. As shown in FIG. 7, the network device 420 may perform the channel available assessment during the transmission gap 730.

At block 540, the network device 420 determines whether the second band is available. For example, if the measured energy on the second band is below threshold energy, the network device 420 may determine that the second band is available. Alternatively, if the strength of the measured signal on the second band is below threshold strength, the network device 420 may determine that the second band is available.

At block 550, the network device 420 performs the second transmission on the second band. As shown in FIG. 6, the network device 420 may perform the transmission 650 on the band 602. As shown in FIG. 7, the network device 420 may perform the transmission 750 on band 602. In some embodiments, the network device 420 may transmit an indication of the transmission gap to the terminal device 410-1. In addition, the network device 420 may transmit the configuration of the transmission gap to the terminal device 410-1. The configuration of the transmission gap may be multi-casted/broadcasted to multiple terminal devices 410.

In some embodiments, the configuration of the transmission gap may be transmitted via radio resource control (RRC) singling. Alternatively, the configuration of the transmission gap may be transmitted via physical layer (PHY) signaling.

In other embodiments, the network device 420 may implicitly indicate the configuration and presence of the transmission gap. For example, the configuration and presence of the transmission gap may be implicitly indicated via slot format indication in group common physical downlink control channel (GC-PDCCH).

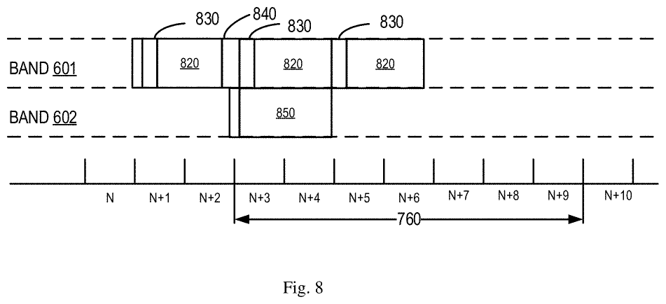

In some embodiments, if the second transmission finishes, the network device 420 may perform the first transmission without transmission gaps. As shown in FIG. 8, the first transmission may comprise control portion 830 and data portion 820. The transmission gap 840 may be created for the transmission 850. The transmission 850 may finish at the slot n+4, there is no gap transmission in the first transmission after slot n+4. In other embodiments, if the window for the second transmission expires, the network device 420 may perform the first transmission without transmission gaps.

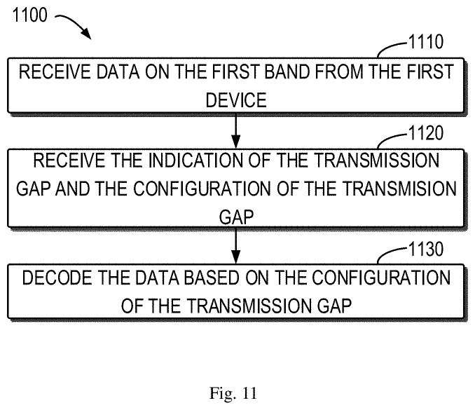

FIG. 11 illustrates a flow chart of a method 1100 in accordance with embodiments of the present disclosure. The method 1100 may be implemented at any suitable devices. Only for the purpose of illustrations, the method 1100 is described to be implemented at the terminal device 410. It should be noted that the method 500 may also be implemented at the network device 410.

At block 1110, the terminal device 410-1 receives data on the first band from the network device 420. In some embodiments, if the terminal device 110-1 receives the first transmission, the terminal device 110-1 may detect whether a puncturing operation is indicated.

At block 1120, the terminal device 410-1 receives an indication of a transmission gap and a configuration of the transmission gap from the first device.

At block 1130, the terminal device 410-1 decodes the data based on the configuration of the transmission gap.

In some embodiments, an apparatus for performing the method 500 (for example, the network device 120) may comprise respective means for performing the corresponding steps in the method 500. These means may be implemented in any suitable manners. For example, it can be implemented by circuitry or software modules.

In some embodiments, the apparatus comprises: means for determining a configuration of a transmission gap; means for generating a transmission gap in a first transmission from a first device to a second device, the first transmission performed on a first band; means for performing a channel available assessment t on a second band during the transmission gap, the second band being adjacent to the first band; means for determining whether the second band is available based on the assessment; and means for in response to a determination that the second band is available, performing a second transmission from the first device to the second device on the second band.

In some embodiments, the means for generating the transmission gap in the first transmission comprises: means for determining an end position of the transmission gap based on a start point of the second transmission; means for determining a duration of the transmission gap based on a duration of the assessment; and means for generating the transmission gap from the determined start position with the determined duration.

In some embodiments, the means for generating the transmission gap in the first transmission comprises: means for determining a period of time in a duration of the first transmission such that no data is transmitted in the period of time; and means for determining the period of time to be the transmission gap.

In some embodiments, the means for generating the transmission gap in the first transmission comprises: means for re-generating a transport block for the first transmission with a new transport block size by avoiding data transmission in the transmission gap.

In some embodiments, the apparatus further comprises means for transmitting an indication of the transmission gap and the configuration of the transmission gap to the second device.

In some embodiments, the apparatus further comprises means for in response to the second transmission being finished, perform the first transmission without the transmission gap.

In some embodiments, the means for performing the channel available assessment on the second band comprises means for performing a listen-before-talk on the second band.

In some embodiments, the apparatus further comprises means for performing the channel available assessment on the first band during the transmission gap.

In some embodiments, the second transmission has a higher priority than the first transmission.

In some embodiments, the first device is a network device and the second device is a terminal device.

In some embodiments, an apparatus for performing the method 1100 (for example, the network device 120) may comprise respective means for performing the corresponding steps in the method 400. These means may be implemented in any suitable manners. For example, it can be implemented by circuitry or software modules.

In some embodiments, the apparatus comprises means for receiving, at a second device, data on a first band from a first device; means for receiving an indication of a transmission gap and a configuration of the transmission gap from the first device, the transmission gap being generated on the first band; and means for decoding the data based on the configuration of the transmission gap.

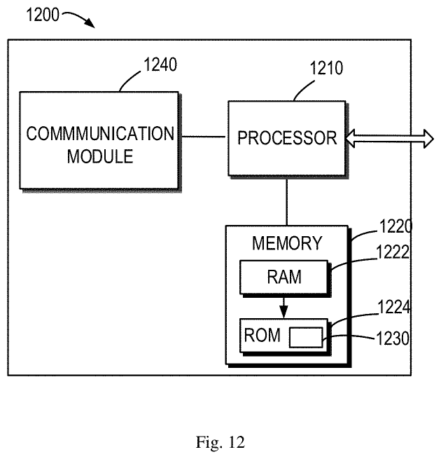

FIG. 12 is a simplified block diagram of a device 1200 that is suitable for implementing embodiments of the present disclosure. The device 1200 may be provided to implement the communication device, for example the network device 420 or the terminal devices 410 as shown in FIG. 4. As shown, the device 1200 includes one or more processors 1210, one or more memories 1220 coupled to the processor 1210, and one or more communication module (for example, transmitters and/or receivers (TX/RX)) 1240 coupled to the processor 1210.

The communication module 1240 is for bidirectional communications. The communication module 1240 has at least one antenna to facilitate communication. The communication interface may represent any interface that is necessary for communication with other network elements.

The processor 1210 may be of any type suitable to the local technical network and may include one or more of the following: general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

The memory 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

A computer program 1230 includes computer executable instructions that are executed by the associated processor 1210. The program 1230 may be stored in the ROM 1224. The processor 1210 may perform any suitable actions and processing by loading the program 1230 into the RAM 1222.

The embodiments of the present disclosure may be implemented by means of the program 1230 so that the device 1200 may perform any process of the disclosure as discussed with reference to FIGS. 5 to 10. The embodiments of the present disclosure may also be implemented by hardware or by a combination of software and hardware.

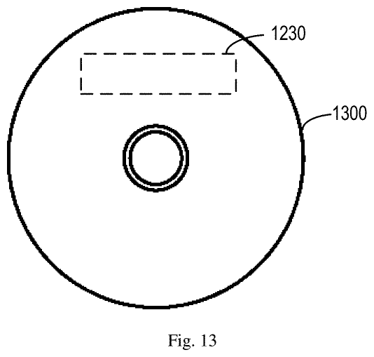

In some embodiments, the program 1230 may be tangibly contained in a computer readable medium which may be included in the device 1200 (such as in the memory 1220) or other storage devices that are accessible by the device 1200. The device 1200 may load the program 1230 from the computer readable medium to the RAM 1222 for execution. The computer readable medium may include any types of tangible non-volatile storage, such as ROM, EPROM, a flash memory, a hard disk, CD, DVD, and the like. FIG. 13 shows an example of the computer readable medium 1300 in form of CD or DVD. The computer readable medium has the program 1230 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500 as described above with reference to FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A first device comprising:
at least one processor; and
at least one memory including computer program codes;
the at least one memory and the computer program codes are configured to, with the at least one processor, cause the first device to,
determine a configuration of a transmission gap;
generate the transmission gap in a first transmission from the first device to a second device, the first transmission performed on a first band;
perform a channel available assessment on a second band during the transmission gap, the second band being adjacent to the first band;
determine whether the second band is available based on the assessment; and
in response to a determination that the second band is available, perform a second transmission from the first device to the second device on the second band.

2. The first device of claim 1, wherein the first device is caused to determine the configuration of the transmission gap by:
determining an end position of the transmission gap based on a start point of the second transmission;
determining a duration of the transmission gap based on a duration of the assessment; and
generating the transmission gap from the determined end position with the determined duration.

3. The first device of claim 1, wherein the first device is caused to generate the transmission gap in the first transmission by:
determining a period of time in a duration of the first transmission such that no data is transmitted in the period of time; and
determining the period of time to be the transmission gap.

4. The first device of claim 1, wherein the first device is caused to generate the transmission gap in the first transmission by:
re-generating a transport block for the first transmission with a new transport block size by avoiding data transmission in the transmission gap.

5. The first device of claim 1, wherein the first device is further caused to:
transmit an indication of the transmission gap and the configuration of the transmission gap to the second device.

6. The first device of claim 1, wherein the first device is further caused to:
in response to the second transmission being finished, perform the first transmission without the transmission gap.

7. The first device of claim 1, wherein the first device is caused to perform the channel available assessment on the second band by:
performing a listen-before-talk on the second band.

8. The first device of claim 1, wherein the first device is further caused to:
perform the channel available assessment on the first band during the transmission gap.

9. The first device of claim 1, wherein the second transmission has a higher priority than the first transmission.

10. The first device of claim 1, wherein the first device is a network device and the second device is a terminal device.

11. A second device comprising:
at least one processor; and
at least one memory including computer program codes;
the at least one memory and the computer program codes are configured to, with the at least one processor, cause the second device to:
receive data on a first band from a first device;
receive an indication of a transmission gap and a configuration of the transmission gap from the first device, the transmission gap being generated on the first band; and
decode the data based on the configuration of the transmission gap.

12. The second device of claim 11, wherein the first device is a network device and the second device is a terminal device.

13. A method comprising:
determining, at a first device, a configuration of a transmission gap;
generating the transmission gap in a first transmission from the first device to a second device, the first transmission performed on a first band;
performing a channel available assessment on a second band during the transmission gap, the second band being adjacent to the first band;
determining whether the second band is available based on the assessment; and
in response to a determination that the second band is available, performing a second transmission from the first device to the second device on the second band.

14. The method of claim 13, wherein determining the configuration the transmission gap comprises:
determining an end position of the transmission gap based on a start point of the second transmission;
determining a duration of the transmission gap based on a duration of the assessment; and
generating the transmission gap from the determined end position with the determined duration.

15. The method of claim 13, wherein generating the transmission gap in the first transmission comprises:
determining a period of time in a duration of the first transmission such that no symbol is transmitted in the period of time; and
determining the period of time to be the transmission gap.

16. The method of claim 13, wherein generating the transmission gap in the first transmission comprises:
re-generating a transport block for the first transmission with a new transport block size by avoiding data transmission in the transmission gap.

17. The method of claim 13, further comprising:
transmitting an indication of the transmission gap and the configuration of the transmission gap to the second device.

18. The method of claim 13, further comprising:
in response to the second transmission being finished, performing the first transmission without the transmission gap.

19. The method of claim 13, wherein performing the channel available assessment on the second band comprises:
performing a listen-before-talk on the second band.

20. The method of claim 13, further comprising:
performing the channel available assessment on the first band during the transmission gap.

21. method of claim 13, wherein the second transmission has a higher priority than the first transmission.

22. The method of claim 13, wherein the first device is a network device and the second device is a terminal device.

23. A method comprising:
receiving, at a second device, data on a first band from a first device;
receiving an indication of a transmission gap and a configuration of the transmission gap from the first device, the transmission gap being generated on the first band; and
decoding the data based on the configuration of the transmission gap.

24. The method of claim 23, wherein the first device is a network device and the second device is a terminal device.

25-28. (canceled)
